(19) United States
(12) Patent Application Publication
(10) Pub. No.: US 2014/0190162 A1
(43) Pub. Date: Jul. 10, 2014

(54) Heat Recovery System for a Gas Turbine Engine

(71) Applicant: Eduardo E. Fonseca, San Antonio, TX (US)

(72) Inventor: Eduardo E. Fonseca, San Antonio, TX (US)

(73) Assignee: FLYSTEAM, LLC, Prairieville, LA (US)

(21) Appl. No.: 14/239,455

(22) PCT Filed: Apr. 7, 2011
(86) PCT No.: PCT/US11/31508

§ 371 Date: Feb. 18, 2014

Related U.S. Application Data
(60) Provisional application No. 61/255,433, filed on Oct. 27, 2009.

(51) Int. Cl. F02B 47/08

(52) U.S. Cl. CPC F02B 47/08
USPC 60/605.1; 60/273

(57) ABSTRACT

A heat recovery system for an engine having an exhaust nozzle whereby exhaust gas is expelled, the heat recovery system comprising a heat exchanger disposed within the exhaust nozzle, heat exchanger containing a fluid, heat exchanger is further positioned to utilize heat energy from exhaust gas to vaporize fluid a turboexpander fluidly connected to heat exchanger and located downstream from heat exchanger, turboexpander further operatively connected to a utility a condenser fluidly connected to turboexpander and located downstream of turboexpander, and a pump fluidly connected to condenser and located between condenser and heat exchanger, pump is configured to direct fluid from condenser to heat exchanger; whereby operation of engine will generate heat energy in exhaust nozzle, vaporize fluid, and create a pressurized vapor which will drive turboexpander.

### PRIORITY CLAIM

This application claims priority to U.S. Non-Provisional patent application Ser. No. 12/912,911, filed on Oct. 27, 2010, the entire contents of which are hereby incorporated by reference

### TECHNICAL FIELD

This invention relates to a heat recovery system in general, and more particularly, to an improved heat recovery system which utilizes otherwise wasted heat energy in the form of exhaust gas from a gas turbine engine.

### BACKGROUND ART

An embodiment of the present invention relates generally to a heat recovery system which utilizes wasted heat energy from the exhaust gases of an airplane's gas turbine engine.

In commercial airplanes, the engine primarily provides thrust, but in addition, it powers many different systems including the pneumatic system, pressurization system, the anti-ice system, and the pressurization of the water and hydraulic system reservoirs The energy needed to run these systems is commonly drawn from the engine's compressor; therefore, the engine must work harder to achieve its selected thrust output. The dependency of the aircraft systems upon the engine creates additional loads on the engine by increasing rotor speed, exhaust gas temperature, and fuel flow while concurrently reducing engine performance. Additionally, the engine uses more fuel, produces more noise and CO2 emissions to enable it to power the above systems of the airplane. Passenger twin engine aircraft consume roughly 9,000 pounds of fuel per hour during cruise depending upon in-flight conditions. The airline passenger feels the effects of this inefficiency because the increase in fuel consumption leads to increased fuel cost which is passed on to the consumer in the form of higher ticket costs.

As stated above, energy from the engine compressor is used to power an aircraft's pneumatic system. A typical aircraft pneumatic system supplies engine compressor air to the cabin. In the transfer of air to the cabin, contamination can occur if the engine has an oil or hydraulic leak. This cabin-air contamination can result in health hazards to passengers and flight crew, flight delays and cancellations which create inconvenience for passengers and decreased revenue for airlines. (one of the applications within this invention eliminates the use of engine's compressor air into the cabin and uses fresh outside air instead, saving fuel and improving cabin air quality. Exhaust gas is generated from the combustion of fuel within a turbofan engine. Combustion of fuel is a series of exothermic chemical reactions which generates a large amount of heat. In conventional airplanes, the exhaust gas flows into the atmosphere through an exhaust nozzle. The exhaust gas can be in the temperature range of 400 to 550 degrees Celsius during cruise and as high as 1000 degrees C. at take off. A percentage of the heat energy generated by the combustion process is lost when the exhaust gas flows into the atmosphere; however, some of the energy that flows through the exhaust nozzle could be transferred in the form of heat energy to the exhaust nozzle itself and/or to the centerbody which is located inside the nozzle. Thus, a device and apparatus for utilizing wasted heat energy in an engine, and especially an airplane engine, is desired.

### OBJECTS OF THE INVENTION

It is an object of the invention to provide a heat recovery system for an engine to utilize wasted heat energy from engine exhaust gases.

It is another object of the invention to decrease fuel consumption in an engine by transferring heat energy captured from engine exhaust gases back to the engine's shaft.

It is yet another object of the invention to provide a heat recovery system for an engine to utilize wasted heat energy from engine exhaust gases to power a compressor.

It is still another object of the invention to provide a heat recovery system for an engine to utilize wasted heat energy from engine exhaust gases to power a generator.

It is a further object of the invention to provide a heat recovery system which can be used in a plurality of engine varieties, including gas turbine engines.

### DISCLOSURE OF THE INVENTION

According to an embodiment of the present invention, a heat recovery system is disclosed which will reduce fuel consumption in aircraft, watercraft, and any other apparatus which utilizes a gas turbine engine. In a preferred embodiment, heat recovery system is configured to capture wasted energy in the form of heat recovered from exhaust gas in an exhaust nozzle of an airplane engine. The heat energy converts fluid into vapor which then can turn a turboexpander which can power various components such as a generator or can be operatively connected to the engine shaft.

### BRIEF DESCRIPTION OF THE FIGURES

FIG. 1 is an interior view of an airplane engine illustrating an embodiment of heat recovery system.

FIG. 2 is a perspective view of an embodiment of heat exchanger.

FIG. 3 is an end view of an embodiment of heat exchanger.

FIG. 4 is an interior view of an airplane engine illustrating an embodiment of heat recovery system.

FIG. 5 is an interior view of an airplane engine illustrating an embodiment of heat recovery system.

FIG. 6 is a perspective view of an embodiment of heat exchanger.

FIG. 7 is an end view of an embodiment of heat exchanger.

FIG. 8 is a flow diagram of an embodiment of heat recovery system.

FIG. 9 is a flow diagram of an embodiment of heat recovery system.

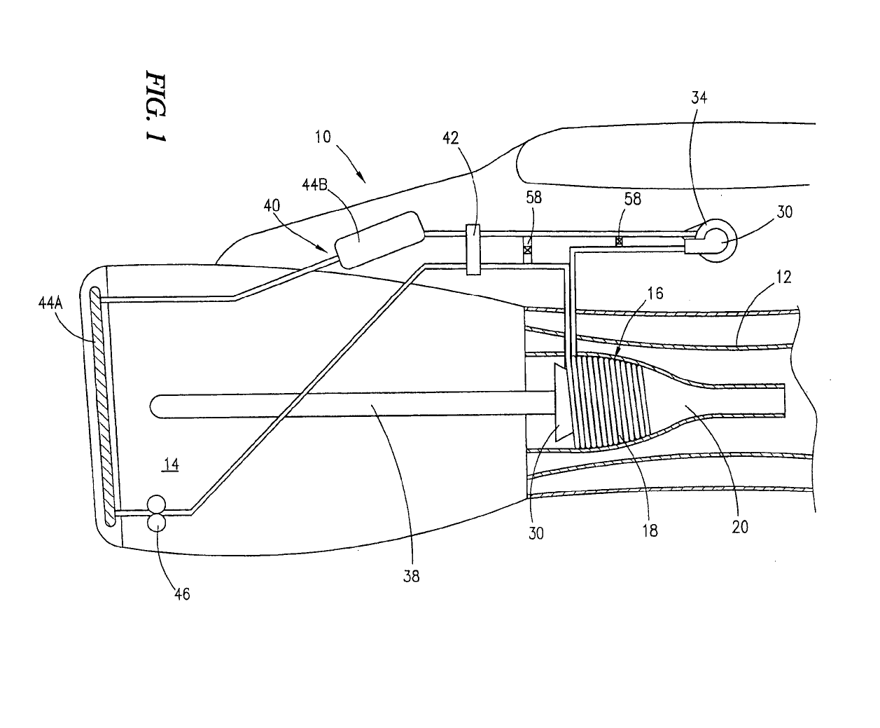

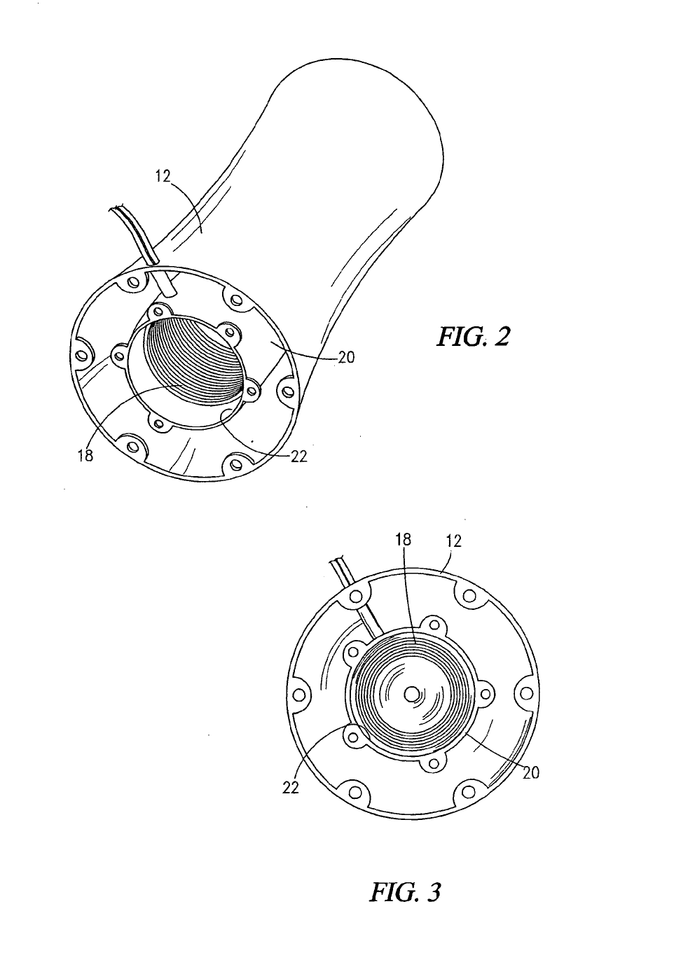

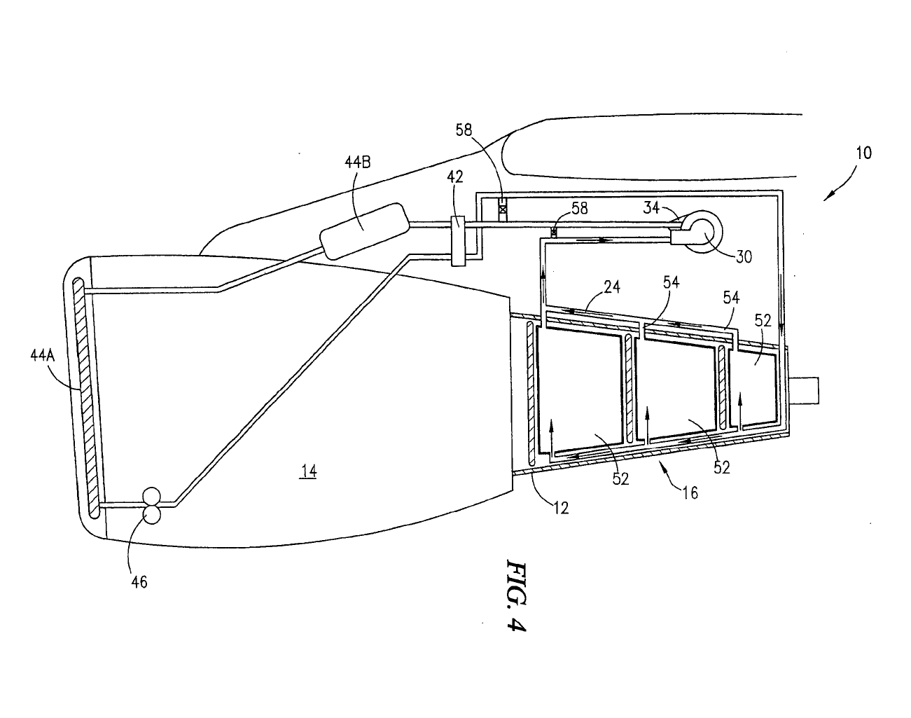

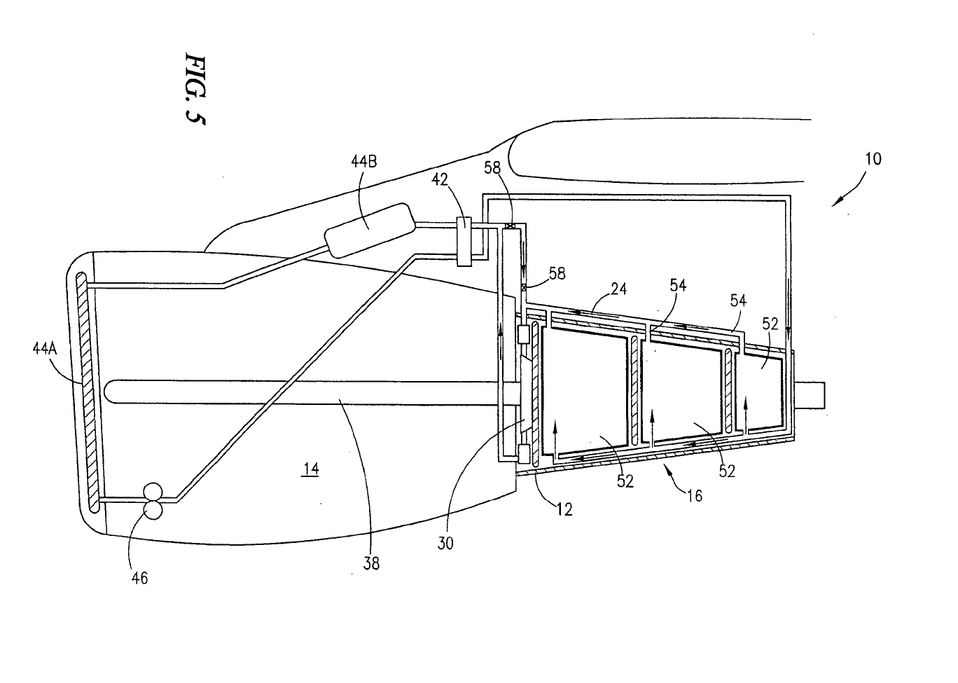

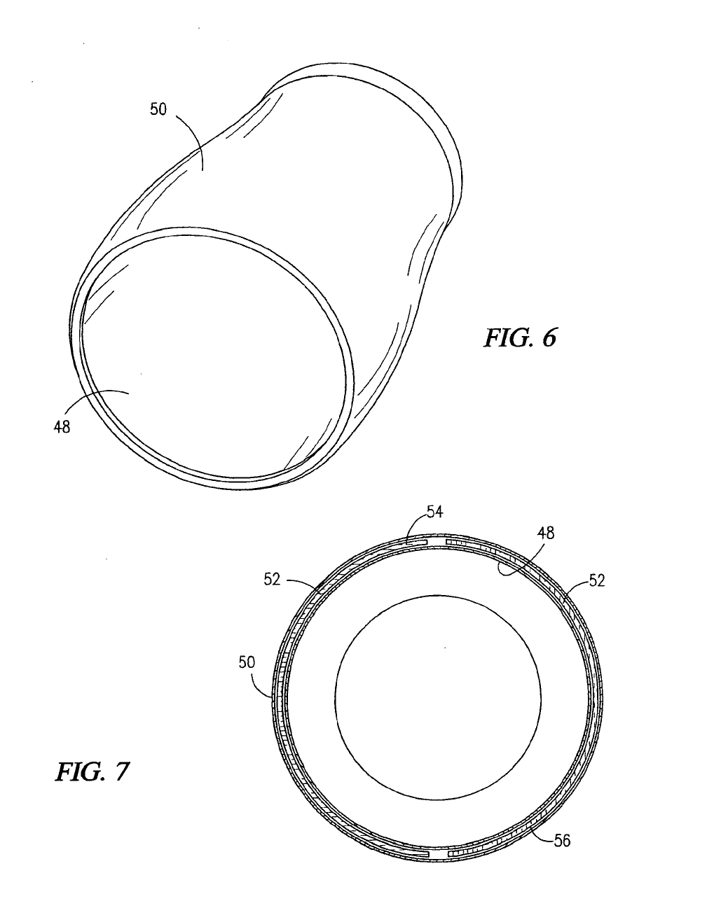

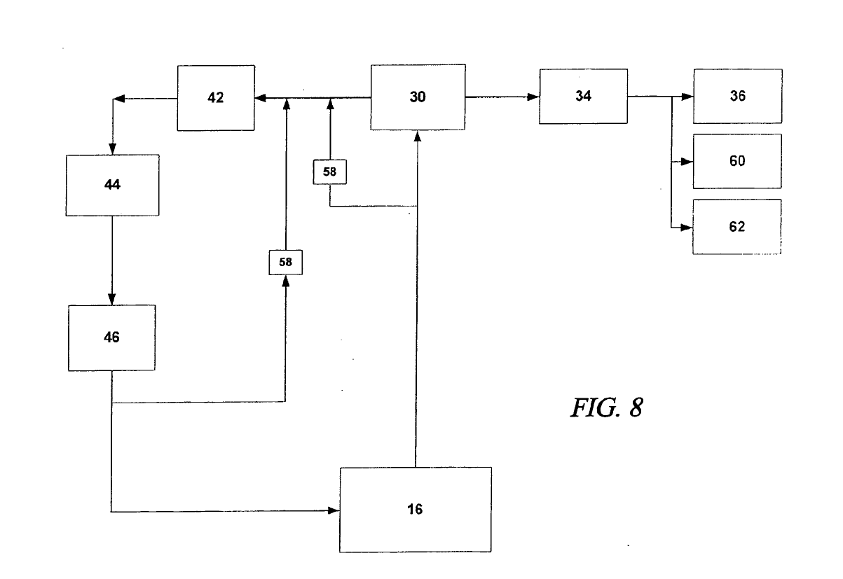

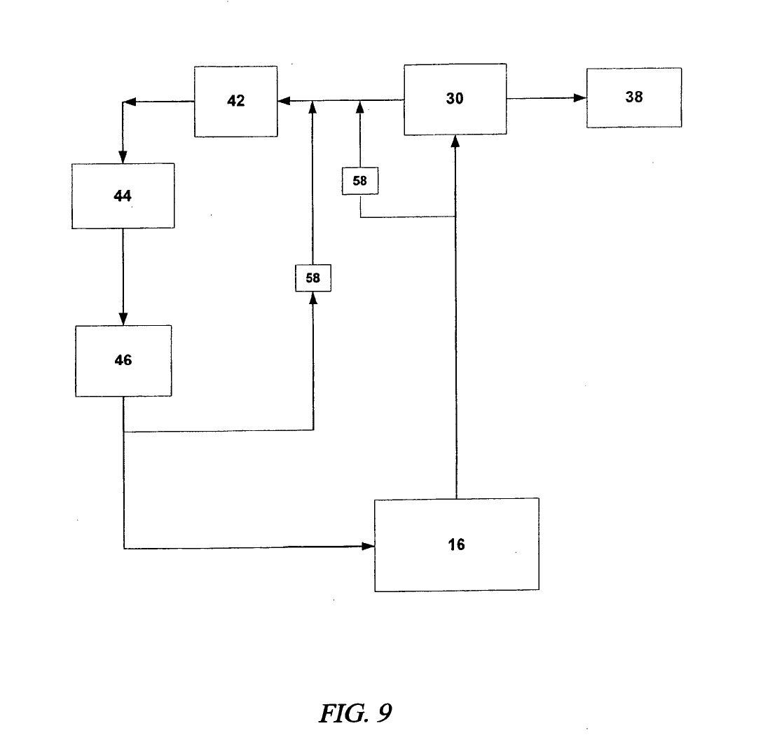

### BEST MODE OF CARRYING OUT THE INVENTION

A heat recovery system 10 utilizing exhaust nozzle 12 of engine 14 is disclosed. Heat recovery system 10 is designed to utilize otherwise wasted energy from exhaust gas which is expelled through exhaust nozzle 12. Heat recovery system 10 can be installed in gas turbine engines for use in aircraft, marine vessels, and any other device having a gas turbine engine.

Engine 14 is equipped with heat recovery system 10 which has a heat exchanger. Heat exchanger 16 can be a substantially hollow coil 18, preferably positioned within centerbody 20. Additionally, coil 18 may adjoin inner surface 22 of the centerbody 20. Coil 18 may have a circular cross section, a substantially rectangular cross section or any other shape which facilitates movement of a fluid 24.

Alternatively, heat exchanger 16 can be a plurality of jackets 52 positioned between inner skin 48 and outer skin 50 of exhaust nozzle 12. Specifically, jackets 52 can be substantially circumferentially disposed within the exhaust nozzle 12 such that a plurality of passageways 54 can be created through which fluid 24 can flow. Jackets 52 can be two sheets 56 of light-weight, heat resistant material welded together to allow fluid 24 to freely circulate between sheets 56. Jackets 52 can be composed of inconel or titanium.

Fluid 24 will preferably be contained within heat exchanger 16. Fluid 24 is preferably an organic-based fluid. Fluid 24 should have a high allowed operating temperature to help heat recovery system 10 reduce entropy loss during heat exchange, evaporation and vapor transfer which results in a higher cycle efficiency of heat recovery system 10. Fluid 24 can be R245fa, R113, or R410a with R245fa exhibiting the highest thermal efficiency.

In heat recovery system 10, exhaust gas passes through exhaust nozzle 12 where it can engage heat exchanger 16. In addition to the above embodiment, heat exchanger 16 can be a plurality of jackets 52 located between inner skin 48 and outer skin 50 of exhaust nozzle 12 Additionally, exhaust nozzle 12 can be fitted with a plurality of fins such that the fins are in contact with exhaust gas. Further, fins can be attached to inner skin 48 of exhaust nozzle 12 such that fins provide additional surface area for heat transfer from exhaust to heat exchanger 16, thereby increasing energy output of heat recovery system 10.

The temperature of the exhaust gas will commonly be between 400 and 600 degrees Celsius during cruise operation conditions. The hot exhaust gas will heat fluid 24 within heat exchanger 16, vaporizing it. When fluid 24 reaches about 28 degrees Celsius, the temperature within the heat exchanger 16 will need to rise to at least 100 degrees Celsius for vaporization to occur. The necessary temperature and flow rate for heat recovery system 10 operation will vary depending upon the particular fluid 24 used and engine operating conditions.

Vaporization of fluid 24 will cause pressure to build in heat exchanger 16. As vapor exits at about 3.89 Kgs/sec and 182 psi in the preferred embodiment, vapor will escape heat exchanger 16 and will travel to at least one turboexpander 30 which can be fluidly connected to heat exchanger 16. Between heat exchanger 16 and turboexpander 30, a pressure control device 58 can be situated to regulate flow of vapor to turboexpander 30.

In its most basic form, turboexpander 30 is a device for converting fluid flow and pressure into mechanical energy. As vapor crosses turboexpander 30, the vapor will lose pressure and the drop in pressure can be used to drive turboexpander 30. Turboexpander 30 can then be used to power external devices. Thus, the pressure drop across turboexpander 30 can be used to power a utility 32. A 3 to 4 stage aluminum blisk type turboexpander with the ability to rotate at about 20,000 to 25,000 RPM should be utilized. A turboexpander 30 meeting the above criteria must be custom designed.

In a first embodiment, utility 32 can be a generator 34. Turboexpander 30 drives generator 34 to produce electricity. The electricity from generator 34 can be used to power a compressor 36. Compressor 36 can be connected to an aircraft's air conditioning and pressurization system. Additionally, generator 34 can be connected to aircraft electrical system 60, pump 62, or any other system which is electrical in nature.

In a second embodiment, utility 32 can be engine shaft 38. In the second embodiment, the energy recovered by heat exchanger 16 can be used to turn turboexpander 30 and directly power engine shaft 38 such that engine utilizes less fuel to produce the same amount of work. In an embodiment, turboexpander 30 can be coupled to engine shaft 38 by mechanical means through a fuse link which can operate as a safety device because the fuse link will break if turboexpander 30 fails.

After the vapor exits turboexpander 30, it will travel to a condensing apparatus 40 where vapor will be condensed into a fluid. Condensing apparatus 40 may be a single component or multiple components. In one embodiment, condensing apparatus 40 comprises a precooler 42 which reduces the temperature of the vapor. From precooler 42, vapor can flow into one or more condensers 44. In an embodiment, condensing apparatus includes a primary condenser 44A and a secondary condenser 44B, though more or fewer condensers 44 may be utilized according to system requirements.

A fluid pump 46 is provided to move the fluid from the condensing apparatus 40 to heat exchanger 16. Fluid pump 46 may be provided between condensing apparatus 40 and the heat exchanger 16 or it may be internal to condensing apparatus 40. Similarly, there may be multiple pumps 46, if desired. In any case, pump 46 moves fluid 24 back to heat exchanger 16. In a preferred embodiment, fluid pump 46 is electrically powered. Additionally, heat recovery system 10 can be fitted with another pressure control device 58 which can be situated to regulate flow of vapor as it returns to heat exchanger 16. Pressure control device 58 can also direct vapor to bypass turboexpander 30 if vapor flow or pressure reach a set level.

In operation, heat exchanger 16 will utilize the heat of the gasses exiting exhaust nozzle 12 to vaporize fluid 24. Vaporized fluid 24 will power one or more turboexpanders 30. From turboexpander 30, the vapor will be condensed by condensing apparatus 40 and returned to heat exchanger 16 by pump 46. Turboexpander 30 will power one or more utilities 32, such as generator 34 or engine shaft 38.

The embodiments shown in the drawings and described above are exemplary of numerous embodiments that may be made within the scope of the appended claims. It is contemplated that numerous other configurations may be used, and the material of each component may be selected from numerous materials other than those specifically disclosed. In short, it is the applicant's intention that the scope of the patent issuing herefrom will be limited by the scope of the appended claims.

1. A heat recovery system for an engine having an exhaust nozzle whereby exhaust gas is expelled, the heat recovery system comprising:
a heat exchanger disposed within said exhaust nozzle, said heat exchanger containing a fluid, said heat exchanger is further positioned to utilize heat energy from said exhaust gas to vaporize said fluid;
a turboexpander fluidly connected to said heat exchanger and located downstream from said heat exchanger; said turboexpander further operatively connected to a utility;
a condenser fluidly connected to said turboexpander and located downstream of said turboexpander; and
a pump fluidly connected to said condenser and located between said condenser and said heat exchanger, said pump configured to direct fluid from the condenser to the heat exchanger; whereby operation of said engine will generate heat energy in said exhaust nozzle, vaporize said fluid, and create a pressurized vapor which will drive said turboexpander.

2. The heat recovery system of claim 1 wherein said engine further comprises a centerbody and said heat exchanger is at least one coil, wherein said coil is disposed within said centerbody.

3. The heat recovery system of claim 1 wherein said exhaust nozzle further comprises an inner skin and an outer skin and said heat exchanger is disposed between said inner skin and said outer skin.

4. The heat recovery system of claim 3 wherein said heat exchanger further comprises a plurality of heat exchange jackets.

5. The heat recovery system of claim 1 wherein said utility is a generator.

6. The heat recovery system of claim 1 wherein said utility is a compressor.

7. The heat recovery system of claim 1 wherein said utility is an engine shaft.

8. The heat recovery system of claim 1 wherein said fluid is water.

9. A method of recovering heat in an engine having an exhaust nozzle whereby exhaust gas is expelled and having a heat recovery system comprising: a heat exchanger disposed within said exhaust nozzle, said heat exchanger containing a fluid, said heat exchanger is further positioned to utilize heat energy from said exhaust gas to vaporize said fluid; a turboexpander fluidly connected to said heat exchanger and located downstream from said heat exchanger; said turboexpander further operatively connected to a utility; a condenser fluidly connected to said turboexpander and located downstream of said turboexpander; and a pump fluidly connected to said condenser and located between said condenser and said heat exchanger, said pump configured to direct fluid from the condenser to the heat exchanger; whereby operation of said engine will generate heat energy in said exhaust nozzle, vaporize said fluid, and create a pressurized vapor which will drive said turboexpander, said method comprising:
Utilizing said heat exchanger to capture said heat energy within said exhaust nozzle to convert said fluid into vapor;
Directing said vapor from said heat exchanger to a turboexpander;
Isentropically expanding said vapor within said turboexpander to power said utility;
Tranforming said vapor into a condensed fluid;
Pumping said condensed fluid back to said heat exchanger.

11. The method of claim 9 wherein said engine further comprises a centerbody and said heat exchanger is at least one coil, wherein said coil is disposed within said centerbody.

12. The method of claim 9 wherein said exhaust nozzle further comprises an inner surface and an outer surface and said heat exchanger is disposed between said inner surface and said outer surface.

13. The method of claim 9 wherein said heat exchanger further comprises a plurality of jackets.

14. The method of claim 9 wherein said utility is a generator.

15. The method of claim 9 wherein said utility is a compressor.

16. The method of claim 9 wherein said utility is an engine shaft.

17. The method of claim 9 wherein said fluid is a refrigerant.
